(19) United States
(12) Patent Application Publication
(10) Pub. No.: US 2025/0296317 A1
(43) Pub. Date: Sep. 25, 2025

(54) PRINT ELEMENT BOARD, PRINT HEAD, AND PRINTING APPARATUS

(71) Applicant: CANON KABUSHIKI KAISHA, Tokyo (JP)

(72) Inventor: HIDENORI YAMATO, Tokyo (JP)

(21) Appl. No.: 19/088,125

(22) Filed: Mar. 24, 2025

(30) Foreign Application Priority Data
Mar. 25, 2024 (JP) 2024-047765

(51) Int. Cl. B41J 2/045

(52) U.S. Cl. CPC B41J 2/04521; B41J 2/0455; B41J 2/04573; B41J 2/04581; B41J 2/04588

(57) ABSTRACT

A print element board includes: a plurality of first print elements; a plurality of second print elements; a plurality of first drive elements configured to drive the plurality of first print elements; a plurality of second drive elements configured to drive the plurality of second print elements; a drive signal generation circuit configured to generate a first drive signal and a second drive signal; and a drive signal selection circuit configured to select both or one of the first drive signal and the second drive signal based on an externally-supplied operation switching signal, and at least one of the first drive elements and at least one of the second drive elements operate based on the drive signal selected by the drive signal selection circuit.

### BACKGROUND OF THE DISCLOSURE

### Field of the Disclosure

The present disclosure relates to a print element board, a print head, and a printing apparatus.

### Description of the Related Art

As a method of driving an inkjet print head (hereinafter, also referred to as “print head”), there is known a method in which electro-thermal transducing elements (heaters) are provided as print elements in portions communicating with ejection ports from which ink droplets are ejected, and an electric current is supplied to these heaters to generate heat and cause the ink droplets to be ejected by film boiling of the ink. A switching element is connected to each heater, and turning on the switching element according to data causes a current to flow in the heater. In order to drive multiple heaters provided to correspond to multiple ejection ports arranged in an array, there is generally used a method in which the multiple heaters are divided into multiple blocks, and the heaters in each block are subjected to time division driving.

The number of print elements in a print element board tends increase with increases in image quality and speed of printing in the recent years. Power supply to the print element board including many print elements to be driven has become a problem with this increase in the number of print elements. A configuration in which timings at which multiple print elements are driven in a time-division block period are shifted among the print elements is sometimes adopted in the print element board to suppress a peak value of a current flowing to the print element board. Japanese Patent Laid-Open No. 2011-235531 (hereinafter, referred to as Literature 1) discloses a circuit that generates a drive signal in a print element board to suppress an increase in the number of terminals used to electrically connect the print element board to a printing apparatus. Moreover, Japanese Patent Laid-Open No. 2020-189448 (hereinafter, referred to as Literature 2) discloses a configuration that generates multiple drive signals varying in timing in one element drive signal generation circuit to suppress a peak value of a current while suppressing the number of terminals and a circuit scale. However, in the case where multiple drive signals are supplied to print elements in separate series in time division, time required for printing increases in proportion to the number of time division, and high-speed printing cannot be executed.

### SUMMARY OF THE DISCLOSURE

According to some embodiments of the present disclosure, the print element board includes: a plurality of first print elements; a plurality of second print elements; a plurality of first drive elements configured to drive the plurality of first print elements; a plurality of second drive elements configured to drive the plurality of second print elements; a drive signal generation circuit configured to generate a first drive signal and a second drive signal; and a drive signal selection circuit configured to select both or one of the first drive signal and the second drive signal based on an externally-supplied operation switching signal. At least one of the first drive elements and at least one of the second drive elements operate based on the drive signal selected by the drive signal selection circuit.

Further features of the present invention will become apparent from the following description of exemplary embodiments with reference to the attached drawings.

### BRIEF DESCRIPTION OF THE DRAWINGS

FIG. 1 is a perspective view illustrating an example of an outer appearance configuration of an inkjet printing apparatus according to an embodiment of the present disclosure;

FIG. 2 is an example of a functional configuration of the printing apparatus illustrated in FIG. 1;

FIG. 3 is a circuit configuration diagram of a print element board according to a first embodiment;

FIG. 4 is a configuration example of a drive signal selection circuit according to the first embodiment;

FIG. 5 is a timing chart illustrating a first operation of the print element board according to the first embodiment;

FIG. 6 is a timing chart illustrating a second operation of the print element board according to the first embodiment;

FIG. 7 is a timing chart illustrating a third operation of the print element board according to the first embodiment;

FIG. 8 is a circuit configuration diagram of a print element board according to a second embodiment;

FIG. 9 is a configuration example of a drive signal selection circuit according to the second embodiment;

FIG. 10 is a timing chart illustrating an operation of the print element board according to the second embodiment;

FIG. 11 is a circuit configuration diagram of a print element board according to a third embodiment; and

FIG. 12 is a timing chart illustrating an operation of the print element board according to the third embodiment.

### DESCRIPTION OF THE EMBODIMENTS

Various exemplary embodiments, features, and aspects will be described below in detail with reference to the accompanying drawings. The embodiments below do not limit the disclosure according to the claims. Not all of a plurality of features written in the embodiments are necessarily essential for the disclosure, and the plurality of features may be optionally combined. Moreover, identical or equivalent components in the accompanying drawings are denoted by the same reference number, and duplicate description thereof is omitted in some cases.

### [Outline of Printing Apparatus]

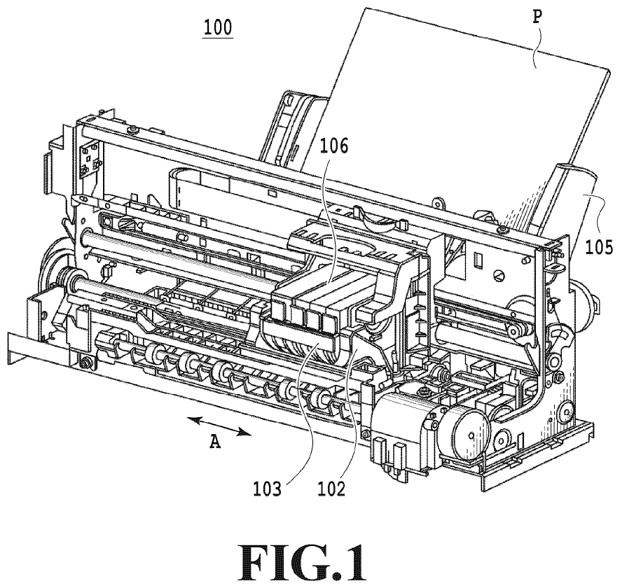

FIG. 1 is an outer appearance perspective view illustrating an outline of a configuration of a printing apparatus that performs printing by using an inkjet print head (hereinafter, print head) being a typical embodiment of the present disclosure.

As illustrated in FIG. 1, in an inkjet printing apparatus (hereinafter, referred to as “printing apparatus”) 100, an inkjet print head (hereinafter, referred to as “print head”) 103 configured to perform printing by ejecting inks according to an inkjet method is mounted in a carriage 102. The printing is performed by reciprocally moving the carriage 102 in an arrow A direction. A print medium P such as print paper is fed via a sheet feeding mechanism 105 to be conveyed to a print position, and the printing is performed by ejecting the inks from the print head 103 to the print medium P at this print position.

Not only the print head 103 is mounted in the carriage 102 of the printing apparatus 100, but also ink tanks 106 configured to store the inks to be supplied to the print head 103 are attached to the carriage 102. The ink tanks 106 are configured to be freely attached to and detached from the carriage 102.

The printing apparatus 100 illustrated in FIG. 1 can perform color printing, and to this end, four ink cartridges storing magenta (M), cyan (C), yellow (Y), and black (K) inks, respectively, are mounted in the carriage 102. These four ink cartridges can each be independently attached and detached.

The print head 103 of the present embodiment adopts an inkjet method in which the inks are ejected by using thermal energy. Accordingly, the print head 103 includes print elements (heaters). The print elements are provided to correspond to ejection ports, respectively, and a pulse voltage is applied to each of the print elements according to a print signal to eject the ink from the corresponding ejection port. Note that the printing apparatus is not limited to the serial type printing apparatus descried above, and the present disclosure can be applied also to a so-called full-line type printing apparatus in which print heads (line heads) in which ejection ports are aligned in a width direction of the print medium are arranged in a conveyance direction of the print medium.

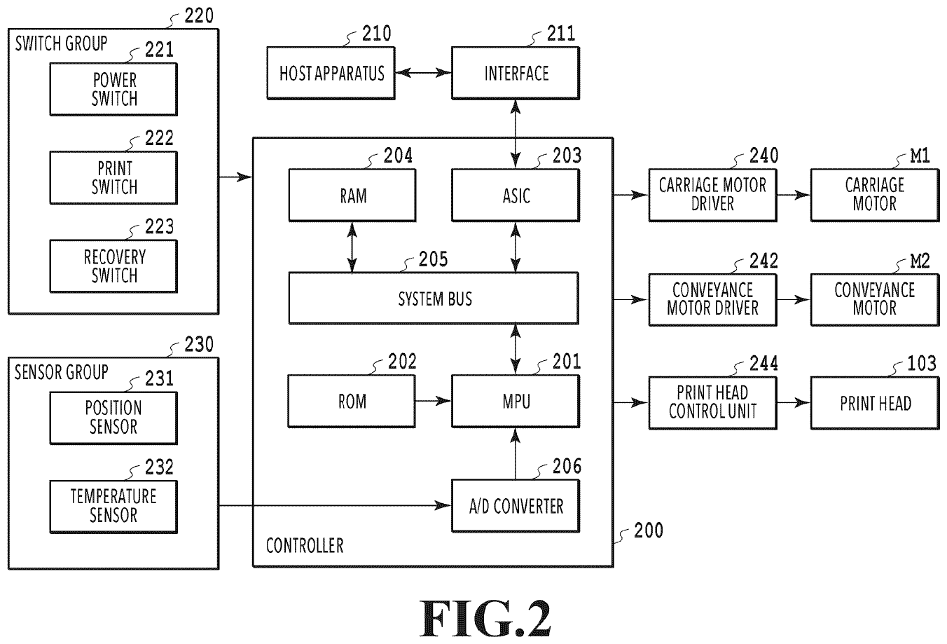

FIG. 2 is a block diagram illustrating a control configuration of the printing apparatus 100 illustrated in FIG. 1.

As illustrated in FIG. 2, a controller 200 is configured to include a MPU 201, a ROM 202, an application specific integrated circuit (ASIC) 203, a RAM 204, a system bus 205, and an A/D converter 206. In this case, the ROM 202 stores a program used by the MPU 201 to control the entire printing apparatus 100, a required table, and other pieces of fixed data. The ASIC 203 performs control of a carriage motor M1 and control of a conveyance motor M2, and generates a control signal for control of the print head 103. The RAM 204 is used as a rendering area of image data, a work area for execution of a program, and the like. The system bus 205 exchanges data by connecting the MPU 201, the ASIC 203, and the RAM 204 to one another. The A/D converter 206 receives analog signals from a sensor group to be explained below, performs A/D conversion of the analog signals, and supplies digital signals to the MPU 201.

Moreover, in FIG. 2, reference numeral 210 denotes a host apparatus such as a personal computer that is a supply source of the image data. The image data, commands, statuses, and the like are exchanged between the host apparatus 210 and the printing apparatus 100 via an interface (I/F) 211 by means of packet communication. Note that the printing apparatus 100 may further include an USB interface as the interface 211, in addition to a network interface, and be configured to be capable of receiving bit data or raster data serially transmitted from the host apparatus 210.

Furthermore, reference numeral 220 denotes a switch group, and the switch group 220 includes a power switch 221, a print switch 222, and a recovery switch 223.

Reference numeral 230 denotes a sensor group for detecting an apparatus state, and the sensor group 230 includes a position sensor 231 and a temperature sensor 232. In the present embodiment, photo sensors configured to detect ink remaining amounts may be provided in addition. Moreover, reference numeral 240 denotes a carriage motor driver configured to drive the carriage motor M1 for reciprocate scanning of the carriage 102 in the arrow A direction. Reference numeral 242 denotes a conveyance motor driver configured to drive the conveyance motor M2 for conveyance of the print medium P.

The ASIC 203 transfers data for driving the print elements (heaters for ink ejection) to the print head 103 while directly accessing a storage area of the RAM 204, in print scanning by the print head 103. In addition, although not illustrated, the printing apparatus 100 includes a display unit formed of an LCD or a LED, as a user interface.

### First Embodiment

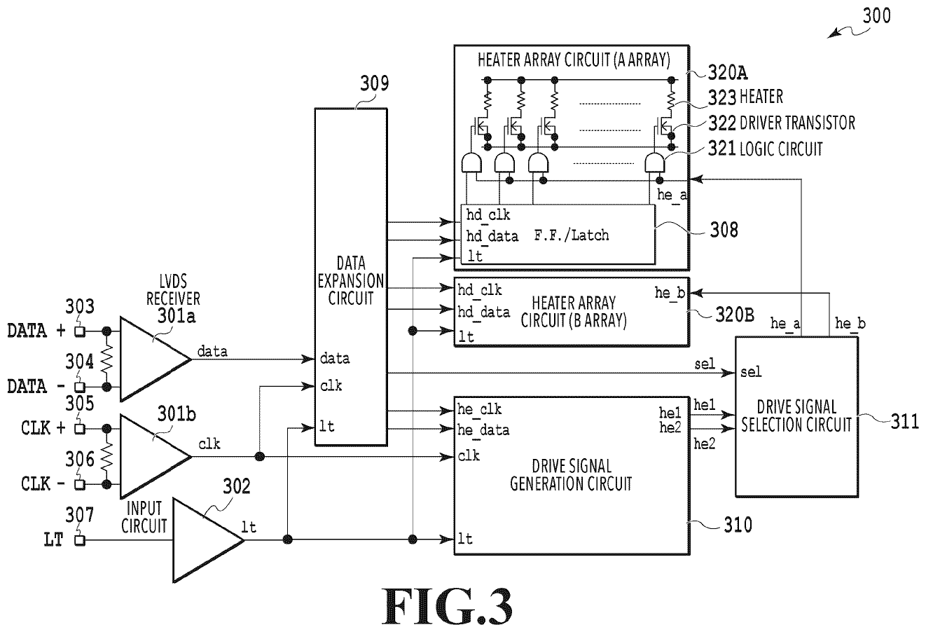

FIG. 3 is a circuit configuration diagram of a print element board according to a first embodiment. As illustrated in FIG. 3, in the print element board 300, LVDS receivers 301a and 301b, an operational amplifier (OP amplifier) 302, and a data expansion circuit 309 are arranged. Moreover, a drive signal generation circuit 310, a drive signal selection circuit 311, and heater array circuits 320A and 320B are further arranged in the print element board 300.

The print element board 300 receives serial signals from a controller of the printing apparatus 100 by using an LVDS method. The LVDS receiver 301a receives the serial signals (DATA+, DATA−) from input terminals 303 and 304, and outputs an internal data signal data. The LVDS receiver 301b receives clock signals (CLK+, CLK−) from input terminals 305 and 306, and outputs an internal clock signal clk. A latch signal (LT) is received from an input terminal 307 as a normal serial signal, and the operational amplifier 302 amplifies the latch signal, and outputs a latch signal lt.

The internal data signal data is supplied to the data expansion circuit 309. The internal clock signal clk is supplied to the data expansion circuit 309 and the drive signal generation circuit 310. The latch signal lt is supplied to the data expansion circuit 309, the heater array circuits 320A and 320B, and the drive signal generation circuit 310.

The data expansion circuit 309 expands the internal clock signal clk and the internal data signal data according to each type, and distributes and transfers signals to the heater array circuits 320A and 320B, the drive signal generation circuit 310, and the drive signal selection circuit 311. Specifically, the data expansion circuit 309 transfers signals hd_clk and hd_data to a serial-parallel conversion circuit 308 included in the heater array circuit 320A. Moreover, the data expansion circuit 309 transfers the signals hd_clk and hd_data to a serial-parallel conversion circuit 308 included in the heater array circuit 320B. In this case, the data hd_data transferred to the serial-parallel conversion circuit 308 of the heater array circuit 320A and the data hd_data transferred to the serial-parallel conversion circuit 308 of the heater array circuit 320B are generally different from each other. Moreover, the data expansion circuit 309 transfers a clock signal he_clk and a common pattern designation signal he_data to the drive signal generation circuit 310. Furthermore, the data expansion circuit 309 transfers an operation switching signal sel to the drive signal selection circuit 311.

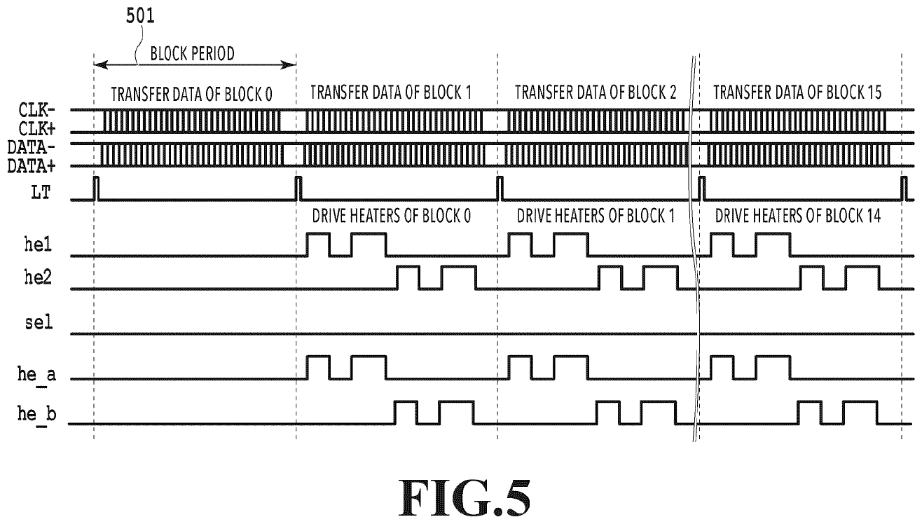

The drive signal generation circuit 310 generates two pre-selection drive signals he1 and he2 based on the supplied internal clock signal clk, clock signal he_clk, common pattern designation signal he_data, and latch signal lt. The drive signal generation circuit 310 is similar to the drive signal generation circuit described in Literature 2. Briefly explaining, the drive signal generation circuit 310 performs serial-parallel conversion with a built-in shift register by using the inputted common pattern designation signal he_data and the inputted clock signal he_clk. The drive signal generation circuit 310 generates the pre-selection drive signals he1 and he2 with multiple built-in counters and a combination circuit, based on timings of rising and falling of the pre-selection drive signals he1 and he2 designated by the common pattern designation signal he_data. For example, the pre-selection drive signals he1 and he2 generated by the drive signal generation circuit 310 are signals as illustrated in FIG. 5. As illustrated in FIG. 5, the pre-selection drive signal he1 is a signal with a double-pulse form which goes into a HIGH level (effective level) twice intermittently in a first portion of each of block periods 501. Moreover, the pre-selection drive signal he2 is a signal with a double-pulse form which goes into a HIGH level (effective level) twice intermittently in a second portion subsequent to the first portion of each block period 501. Note that, as described in Literature 2, the drive signal generation circuit 310 repeats the same operation twice in one block period. Accordingly, the pattern shape of the double pulse of the pre-selection drive signal he1 is the same as the pattern shape of the double pulse of the pre-selection drive signal he2.

The drive signal selection circuit 311 selects one of the pre-selection drive signal he1 and the pre-selection drive signal he2 as a post-selection drive signal he_a, depending on an operation mode designated by the operation switching signal sel. Note that, in the first embodiment, the drive signal selection circuit 311 may be a circuit that always selects the pre-selection drive signal he1 as the post-selection drive signal he_a. Moreover, the drive signal selection circuit 311 selects one of the pre-selection drive signal he1 and the pre-selection drive signal he2 as a post-selection drive signal he_b, depending on the operation mode designated by the operation switching signal sel. Then, the drive signal selection circuit 311 supplies the post-selection drive signal he_a to multiple control circuits 321 included in the heater array circuit 320A, and supplies the post-selection drive signal he_b to multiple control circuits 321 included in the heater array circuit 320B.

Each of the heater array circuits 320 includes multiple print elements (heaters) 323 configured to heat and eject the ink in the assigned nozzles and multiple drive elements (driver transistors) 322 configured to drive the multiple print elements 323, respectively. Transistors such as MOSFETs are used as the drive elements 322. Furthermore, the heater array circuit 320 includes the serial-parallel conversion circuit 308. The serial-parallel conversion circuit 308 includes a shift register (not illustrated) including multiple flip-flop circuits connected in series and multiple latch circuits (not illustrated) corresponding to the multiple flip-flop circuits, respectively. The shift register shifts the signal hd_data by using the clock signal hd_clk. Each of the multiple latch circuits latches an output of the corresponding flip-flop circuit in the shift register as an element selection signal by using the signal lt. The heater array circuit 320 includes multiple control circuits 321 that calculate logical products of the element selection signals supplied from the respective latches (not illustrated) in the serial-parallel conversion circuit 308 and the post-selection drive signal (to be described later) supplied from the drive signal selection circuit 311. In this example, the control circuits 321 are logic circuits, and are AND circuits. Accordingly, the control circuit 321 in which the inputted element selection signal is at an effective level and the inputted post-selection drive signal is at an effective level activates the drive element 322 corresponding to this control circuit 321, and the corresponding print element 323 is thereby driven. In this example, in the case where the control circuit 321 is the AND circuit, the effective level is a HIGH level. Moreover, in the case where the drive element 322 is a transistor, the drive element 322 being activated means the drive element 322 being set to a conductive state.

In the example illustrated in FIG. 3, the heater array circuit 320A and the heater array circuit 320B are mounted in the print element board 300 as the heater array circuits 320. The heater array circuit 320B has an internal configuration similar to the heater array circuit 320A. Accordingly, the multiple print elements 323, the multiple drive elements (driver transistors) 322, the multiple control circuits 321, and the serial-parallel conversion circuit 308 belonging to an A array are present in the print element board 300. Moreover, the multiple print elements 323, the multiple drive elements (driver transistors) 322, the multiple control circuits 321, and the serial-parallel conversion circuit 308 belonging to a B array are also present in the print element board 300. Note that the number of heater array circuits is not limited to two, and may be more. For example, a heater array circuit 320C and a heater array circuit 320D may be added. In this case, the configuration may be such that the individual signals hd_clk, hd_data, and lt are supplied from the data expansion circuit 309 to the heater array circuit 320C and the heater array circuit 320D. Moreover, the configuration may be such that the post-selection drive signal he_a is supplied to the heater array circuit 320C and the post-selection drive signal he_b is supplied to the heater array circuit 320D.

FIG. 5 is a timing chart illustrating a first operation of the print element board 300 according to the first embodiment. FIG. 5 illustrates an example in which the multiple drive elements 322 corresponding to the multiple print elements 323 are divided into 16 blocks (blocks 0 to 15), and the divided multiple drive elements 322 performs time division driving on the multiple print elements 323.

As illustrated in FIG. 5, in the time division driving, data transmission for block_(n+1) and drive of the print elements 323 of block_n are simultaneously performed in each block period 501. Specifically, in each block period 501, DATA+ and DATA− that are a differential signal is transferred in synchronization with CLK+ and CLK− that are a differential signal, from a main body portion of the printing apparatus 100. The LVDS receivers 301a and 301b in FIG. 3 convert these differential signals to the single-end internal clock signal clk and the internal data signal data, respectively, and transfers the signals to the data expansion circuit 309. The data expansion circuit 309 further expands the internal clock signal clk and the internal data signal data according to each type, and distributes and transfers the signals to the heater array circuits 320A and 320B, the drive signal generation circuit 310, and the drive signal selection circuit 311. Specifically, the data expansion circuit 309 transmits hd_clk and hd_data for the A array to the shift register of the serial-parallel conversion circuit 308 of the heater array circuit 320A. Moreover, the data expansion circuit 309 transmits hd_clk and hd_data for the B array to the shift register of the serial-parallel conversion circuit 308 of the heater array circuit 320B. Furthermore, the data expansion circuit 309 transmits the clock signal he_clk and the common pattern designation signal he_data to the shift register of the drive signal generation circuit 310. Moreover, the data expansion circuit 309 transmits the operation switching signal sel to the drive signal selection circuit 311.

Meanwhile, the latch signal LT in which a latch pulse is generated for each block period 501 is amplified by the operational amplifier 302, and is transferred to multiple circuits included in the print element board 300 as the internal signal lt. The multiple circuits being the transfer destinations include the data expansion circuit 309, the drive signal generation circuit 310, the latch circuits in the serial-parallel conversion circuit 308 of the heater array circuit 320A, and the latch circuits in the serial-parallel conversion circuit 308 of the heater array circuit 320B.

Next, a latch pulse of the signal lt is generated at the beginning of the next block period 501. At the timing of rising of the latch pulse, the internal signal hd_data transferred to the serial-parallel conversion circuit 308 of the heater array circuit 320A in the previous block period 501 is stored in the latch circuits in the serial-parallel conversion circuit 308 as a first element selection signal. The print elements 323 in the A array to be driven are thereby selected. The numbers of the print elements 323, the drive elements 322, the control circuits 321, and the latch circuits in the serial-parallel conversion circuit 308 are the same, and the print elements 323, the drive elements 322, the control circuits 321, and the latch circuits in the serial-parallel conversion circuit 308 are associated with one another, respectively. For example, only the element selection signal outputted by one latch circuit goes into the HIGH level (effective level), and the drive element 322 corresponding to this element selection signal drives the print element 323 corresponding to this drive element 322 at a timing at which the post-selection drive signal he_a goes into the HIGH level (effective level).

The heater array circuit 320B also operates in a similar manner. For example, only the element selection signal outputted by one latch circuit in the B array thus goes into the HIGH level (effective level). Then, the drive element 322 corresponding to this element selection signal drives the print element 323 corresponding to this drive element 322 at a timing at which the post-selection drive signal he_b goes into the HIGH level (effective level).

Note that the element selection signal latched by the latch circuit is maintained until the next latch pulse is generated, and is updated by the next latch pulse.

Note that, although the explanation partially overlaps, DATA transmitted from the outside includes the operation switching signal sel for designating which pre-selection drive signal is to be selected as the post-selection drive signal. The operation switching signal sel is expanded in the data expansion circuit 309, and transmitted to the drive signal selection circuit 311.

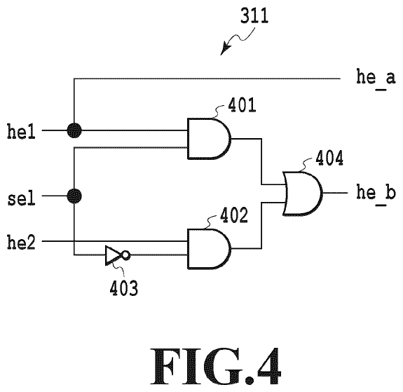

FIG. 4 illustrates a configuration example of the drive signal selection circuit according to the present embodiment. The drive signal selection circuit illustrated in FIG. 4 includes a logical product gate 401 that calculates a logical product of he1 and sel and a logical inversion gate 403 that performs logical inversion on sel.

Moreover, the drive signal selection circuit further includes a logical product gate 402 that calculates a logical product of he2 and sel subjected to logical inversion and a logical sum gate 404 that calculates a logical sum of an output of the logical product gate 401 and an output of the logical product gate 402.

Based on FIG. 4, the following is satisfied:

$$he\_a = he 1 \\ he\_b = sel \cdot he 1 + ! sel \cdot he 2$$

where ! indicates logical inversion.

Accordingly, the first pre-selection drive signal he1 (one of the first pre-selection drive signal he1 and the second pre-selection drive signal he2) is always used as the first post-selection drive signal he_a. Moreover, in the case where the operation switching signal sel is at the LOW level and the first operation mode is designated, the second pre-selection drive signal he2 (other one of the first pre-selection drive signal he1 and the second pre-selection drive signal he2) is used as the second post-selection drive signal he_b. Meanwhile, in the case where the operation switching signal sel is at the HIGH level and the second operation mode is designated, the first pre-selection drive signal he1 (one of the first pre-selection drive signal he1 and the second pre-selection drive signal he2) is used as the second post-selection drive signal he_b.

Accordingly, in the case where the operation switching signal sel is at the LOW level and the first operation mode is designated, the relationships as illustrated in FIG. 5 are satisfied. Specifically, the relationships of the first pre-selection drive signal he1, the second pre-selection drive signal he2, the first post-selection drive signal he_a, and the second post-selection drive signal he_b are as illustrated in FIG. 5. As apparent from FIG. 5, the first post-selection drive signal he_a includes a double pulse in the first portion of each block period 501, and the second post-selection drive signal he_b includes a double pulse in a portion subsequent to the first portion. Accordingly, it is possible to avoid overlapping of a timing at which the print elements 323 in the A array are operated and a timing at which the print elements 323 in the B array are operated, and this can suppress a peak current and reduce a voltage drop. Accordingly, image quality can be increased. Since an ejection count (for example, the number of print elements to be driven) is large particularly in a high image quality mode, the first operation mode is preferable for the high-image quality mode.

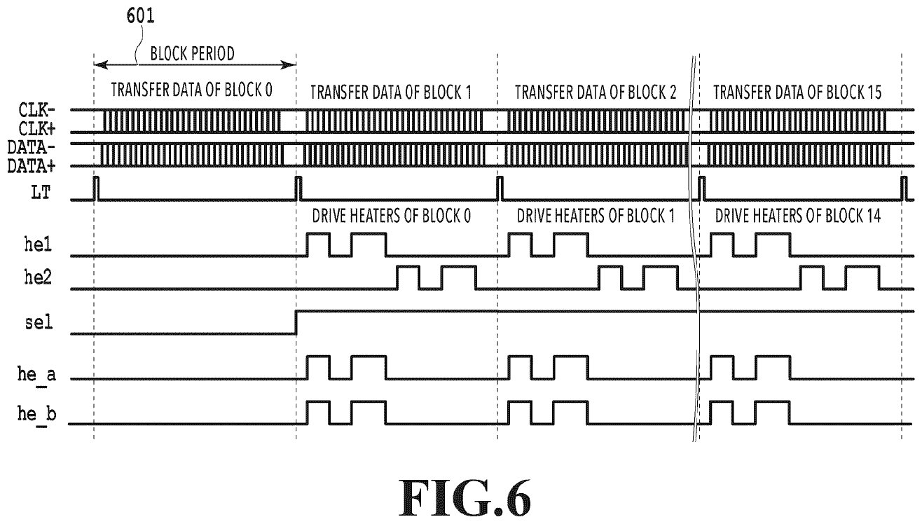

In the case where the operation switching signal sel is at the HIGH level and the second operation mode is designated, the relationships of the first pre-selection drive signal he1, the second pre-selection drive signal he2, the first post-selection drive signal he_a, and the second post-selection drive signal he_b are as illustrated in FIG. 6. As apparent from FIG. 6, the first post-selection drive signal he_a includes a double pulse in the first portion of each of block periods 601, and the second post-selection drive signal he_b includes a double pulse in the same portion (that is, at the same timing). Note that the duration of each block period 501 illustrated in FIG. 5 and the duration of each block period 601 illustrated in FIG. 6 are the same.

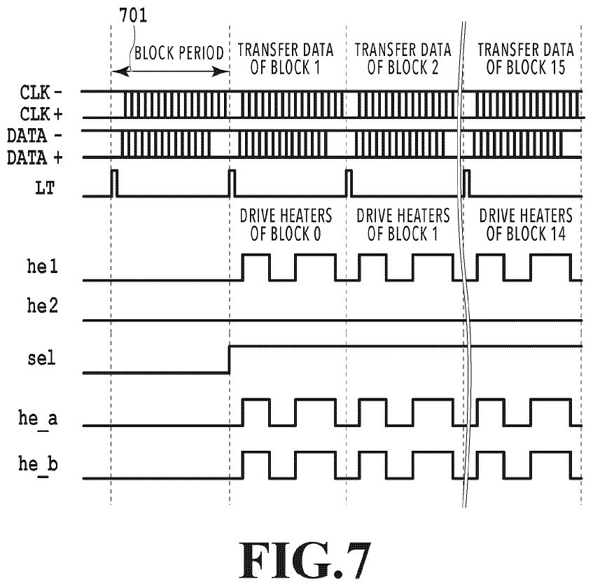

FIG. 7 is a timing chart in the case where the block period is shortened from that in the case illustrated in FIG. 6. Each of block periods 701 illustrated in FIG. 7 has about half the duration of each block period 601 illustrated in FIG. 6. Note that, also in the case illustrated in FIG. 7, the operation switching signal sel is at the HIGH level, and the second operation mode is designated.

As illustrated in FIG. 7, designating the second operation mode as the operation mode allows the print elements 323 of the A array and the print elements 323 of the B array to be driven also in the case where the block period is shortened. Accordingly, the print time can be reduced. In the case of FIG. 7, since the duration of the block period is about half the duration in the case of FIG. 6, the print time can be substantially halved from that in FIG. 6. Note that the block periods 701 are set such that data transmission necessary for one block can be completed in each block period 701. Accordingly, the block period can be further shortened as long as no post-selection drive signals he_a and he_b are lost and the data transmission necessary for one block can be completed in each block period 701. The second operation mode is preferable for reduction of the print time, though there is a possibly that the image quality decreases from that in the first operation mode. The print time may be further reduced by changing the common pattern designation signal he_data and reducing the pulse length of the first pre-selection drive signal he1 (accordingly, the first post-selection drive signal he_a and the second post-selection drive signal he_b).

According to the present embodiment, the operation mode can be switched between the first operation mode and the second operation mode depending on whether to focus on high image quality or short print time. For example, it is possible to select the first operation mode in the case where the user selects high image quality printing, and select the second operation mode in the case where the user selects high speed printing. Moreover, the operation mode can be switched between the first operation mode and the second operation mode depending on the type of print medium to be subjected to printing.

Moreover, according to the present embodiment, the drive signal generation circuit 310 that generates two drive signal while having a small circuit scale can be used as it is. Moreover, only one drive signal selection circuit 311 is necessary, and the number of gates is small. Accordingly, in the present embodiment, the circuit scale can be reduced.

In the above-mentioned configuration, the operation switching signal sel is supplied from the outside to the drive signal selection circuit 311 via the terminals 303 and 304, the receiver 301a, and the data expansion circuit 309. However, the configuration is not limited to this, and the operation switching signal sel may be supplied from the outside to the drive signal selection circuit 311 via not-illustrated terminals and wiring lines.

The post-selection drive signal supplied to each heater array circuit 320 may be delayed for each drive element 322 in the heater array circuit 320. To this end, for example, in the case where multiple print elements 323 are selected in the same heater array circuit 320, a delay element may be inserted in a drive signal wiring line between right input terminals of each adjacent two of the logical product gates that function as control circuits 321 in the heater array circuits 320. Moreover, in the case where a common post-selection drive signal is used in the multiple heater array circuits 320, the post-selection drive signal may have a time lag between the multiple heater array circuits 320. To this end, for example, there may be added a delay element that delays the post-selection drive signal supplied to the heater array circuit 320A by a first delay time. Moreover, a delay element that delays the post-selection drive signal supplied to the heater array circuit 320B by a second delay time may be added, or both delay elements may be added. Furthermore, for example, delaying the drive signal for every unit of the time division can prevent the case where the drive elements are simultaneously turned on and off and the voltage abruptly fluctuates.

### Second Embodiment

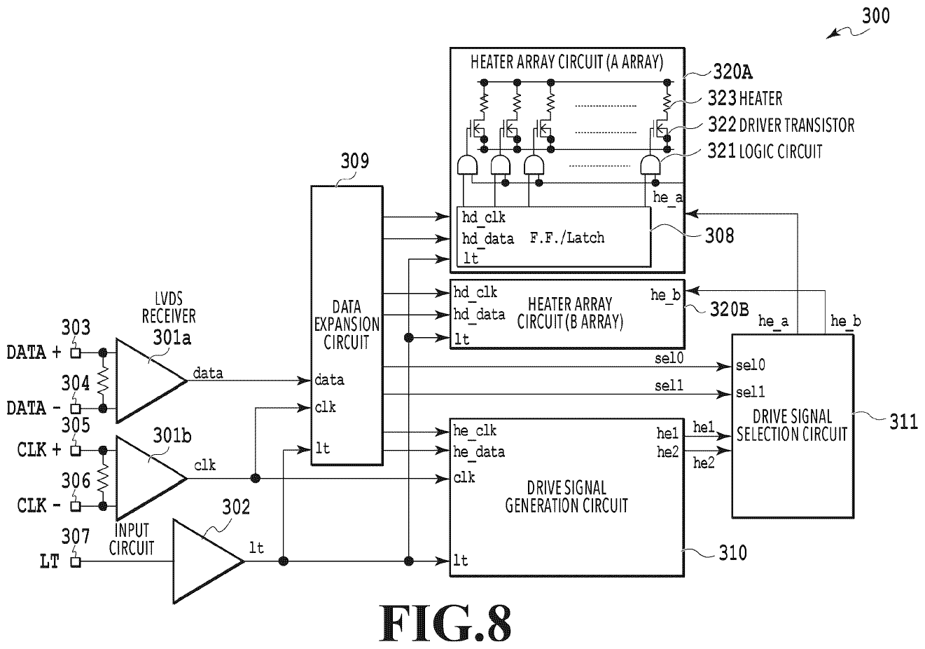

FIG. 8 is a circuit configuration diagram of a print element board according to a second embodiment. Note that, in FIG. 8, the same constituent elements as the constituent elements already explained with reference to the drawings are denoted by the same reference numerals, and overlapping explanation is omitted.

As illustrated in FIG. 8, operation switching signals sel0 and sel1 with a two-bit configuration are transmitted from the data expansion circuit 309 to the drive signal selection circuit 311.

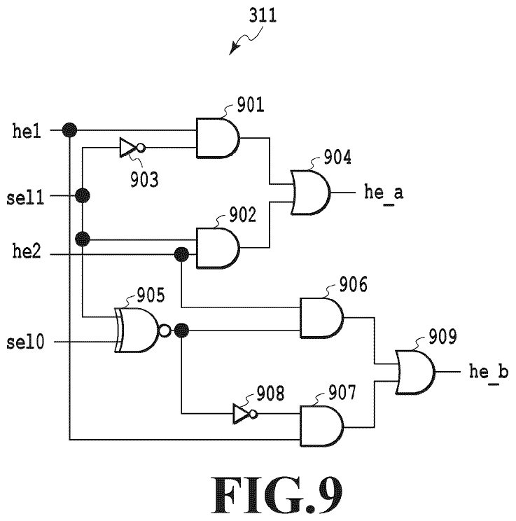

FIG. 9 illustrates a configuration example of the drive signal selection circuit according to the second embodiment. The drive signal selection circuit illustrated in FIG. 9 includes a logical product gate 901 that calculates a logical product of he1 and sel1 and a logical inversion gate 903 that performs logical inversion on sel1. Moreover, the drive signal selection circuit illustrated in FIG. 9 includes a logical product gate 902 that calculates a logical product of he2 and sel1 subjected to the logical inversion and a logical sum gate 904 that calculates a logical sum of an output of the logical product gate 901 and an output of the logical product gate 902. Furthermore, the drive signal selection circuit illustrated in FIG. 9 includes an exclusive logical sum gate 905 that calculates an exclusive logical sum of sel0 and sel1 and a logical product gate 906 that calculates a logical product of he2 and an output of the exclusive logical sum gate 905. Moreover, the drive signal selection circuit illustrated in FIG. 9 includes a logical inversion gate 908 that performs local inversion on the output of the exclusive logical sum gate 905 and a logical product gate 907 that calculates a logical product of he1 and an output of the logical inversion gate 908. Furthermore, the drive signal selection circuit illustrated in FIG. 9 includes a logical sum gate 909 that calculates a logical sum of an output of the logical product gate 906 and an output of the logical product gate 907.

Based on FIG. 9, the following is satisfied:

$$he\_a = ! sel 1 \cdot he 1 + sel 1 \cdot he 2 \\ he\_b = ( sel 1 * sel 0 ) \cdot he 1 + ! ( sel 1 * sel 0 ) \cdot he 2$$

where ! is logical inversion and * is exclusive logical sum.

Accordingly, in the case where sel0=LOW,

$$he\_a = ! sel 1 \cdot he 1 + sel 1 \cdot he 2 \\ he\_b = sel 1 \cdot he 1 + ! sel 1 \cdot he 2$$

is satisfied.

Moreover, in the case where sel0=HIGH,

$$he\_a = ! sel 1 \cdot he 1 + sel 1 \cdot he 2 \\ he\_b = ! sel 1 \cdot he 1 + sel 1 \cdot he 2$$

is satisfied.

Accordingly, in the case where sel0=LOW and sel1=LOW,

he_a=he1

he_b=he2

is satisfied, and this corresponds to the first operation mode in the first embodiment.

Moreover, in the case where sel0=HIGH and sel1=LOW,

he_a=he1

he_b=he1

is satisfied, and this corresponds to the second operation mode in the first embodiment.

Overlapping explanation of the first operation mode and the second operation mode is omitted.

The second embodiment includes the following new combinations.

In the case where sel0=LOW and sel1=HIGH,

he_a=he2

he_b=he1

is satisfied, and this is referred to as third operation mode.

In the case where sel0=HIGH and sel1=HIGH

he_a=he2

he_b=he2

is satisfied, and this is referred to as fourth operation mode.

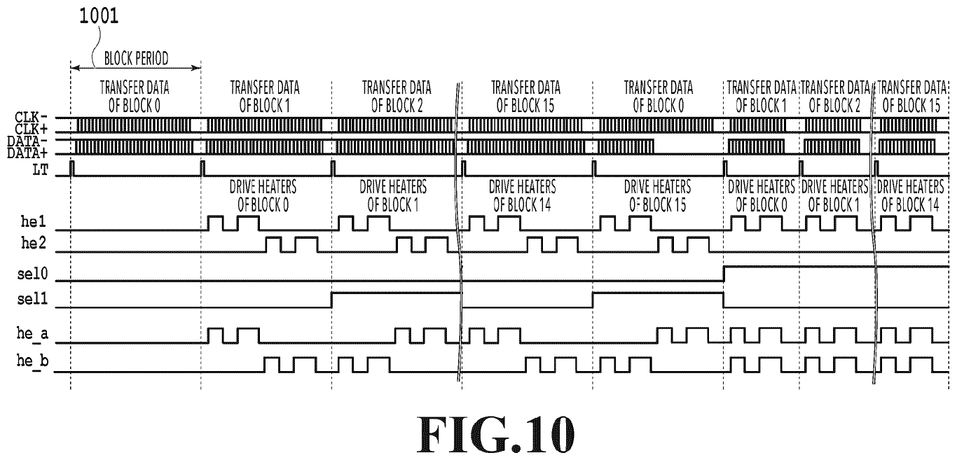

The first post-selection drive signal and the second post-selection drive signal in the third operation mode are such signals that the first post-selection drive signal and the second post-selection drive signal in the first operation mode are interchanged with each other. Accordingly, in the case where the first operation mode and the third operation mode are each performed every other block period to be alternately repeated as illustrated in FIG. 10, the first post-selection drive signal and the second post-selection drive signal are as follows. Specifically, a block period in which the first post-selection drive signal has the double pulse before the second post-selection drive signal and a block period in which this order is reversed are alternately repeated. Note that, as illustrated FIG. 10, it is assumed that the first pre-selection drive signal has the double pulse in the first portion of each block period, and the second pre-selection drive signal has the double pulse in the portion subsequent to the first portion.

In the case where only the first operation mode is selected and the ink ejection is continued in the same block periods by using the same nozzles, there may occur a case where the oscillation of voltage becomes dependent on nozzle locations and unevenness occurs in printing. Meanwhile, in the case where the operation mode is switched such that the first operation mode and the third operation mode are each performed every other block period to be alternately repeated, such printing unevenness can be suppressed.

Next, the fourth operation mode is explained. The second pre-selection drive signal he2 is selected as the first post-selection drive signal he_a, and is also selected as the second post-selection drive signal he_b. In this case, as illustrated in FIG. 10, in each of block periods 1001, the double pulse of the second pre-selection drive signal he2 is generated after the double pulse of the first pre-selection drive signal he1. Accordingly, the first post-selection drive signal he_a and the second post-selection drive signal he_b are maintained at the LOW level in the period in which the double pulse of the first pre-selection drive signal he1 is generated. Thereafter, the double pulses of the first post-selection drive signal he_a and the post-selection drive signal he_b are simultaneously generated. The fourth operation mode may be selected, for example, in the case where the driving of the print elements needs to be avoided in the first half of the block period from a viewpoint of noise or the like.

### Third Embodiment

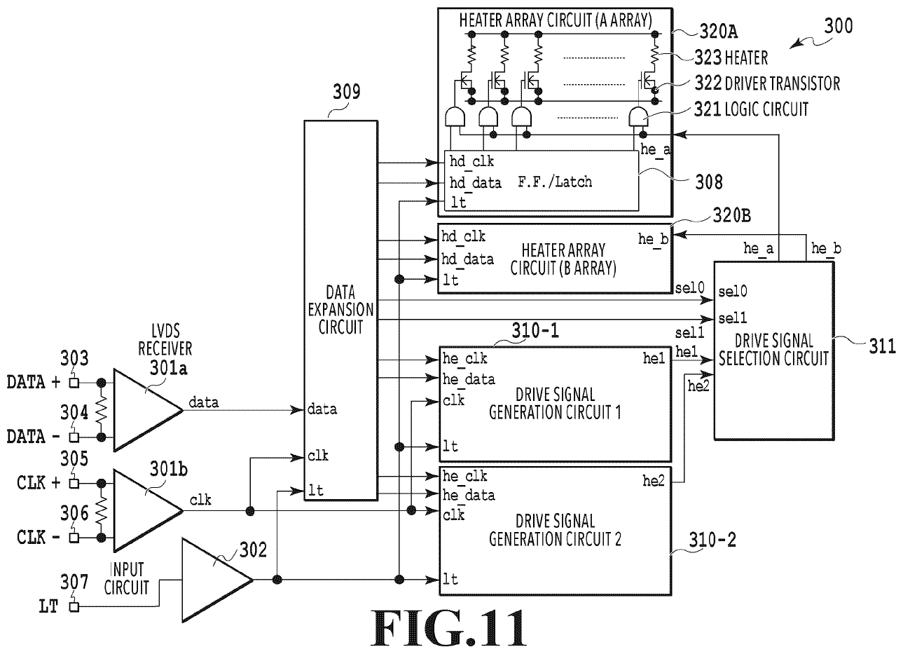

FIG. 11 is a circuit configuration diagram of a print element board according to a third embodiment. Note that, in FIG. 11, the same constituent elements as the constituent elements already explained with reference to the drawings are denoted by the same reference numerals, and overlapping explanation is omitted.

In the present embodiment, two drive signal generation circuits 310-1 and 310-2 are arranged in the print element board 300. In the configuration illustrated in FIG. 3 and the configuration illustrated in FIG. 8, the drive signal generation circuit 310 generates the two pre-selection drive signals he1 and he2. Accordingly, it is possible to assume that a portion configured to generate the pre-selection drive signal he1 and a portion configured to generate the pre-selection drive signal he2 are common. Meanwhile, in the configuration of the present embodiment illustrated in FIG. 11, the portion configured to generate the pre-selection drive signal he1 and the portion configured to generate the pre-selection drive signal he2 are provided separately as the drive signal generation circuits 310-1 and 310-2.

The drive signal generation circuits 310-1 and 310-2 receive a common clock signal and a common latch signal lt. However, the drive signal generation circuits 310-1 and 310-2 receive separate clock signals he_clk and individual pattern designation signals he_data. A first individual pattern designation signal he_data supplied to the drive signal generation circuit 310-1 and a second individual pattern designation signal he_data supplied to the drive signal generation circuit 310-2 designate pre-selection drive signals having double pulse waveforms different from each other. The drive signal generation circuit 310-1 may be a circuit that generates two pre-selection drive signals. In this case, the drive signal generation circuit 310-1 uses one of the pre-selection drive signals in which the double pulse is generated at the earlier timing, as the pre-selection drive signal he1 supplied to the drive signal selection circuit 311. The drive signal generation circuit 310-2 may also be a circuit that generates two pre-selection drive signals. In this case, the drive signal generation circuit 310-2 uses one of the pre-selection drive signals in which the double pulse is generated at the later timing, as the pre-selection drive signal he2 supplied to the drive signal selection circuit 311. Note that the drive signal generation circuit 310-1 may be a circuit that generates one double pulse, and the drive signal generation circuit 310-2 may also be a circuit that generates one double pulse. In this case, the double pulse waveform of the pre-selection drive signal he1 supplied to the drive signal selection circuit 311 and the double pulse waveform of the pre-selection drive signal he2 supplied to the drive signal selection circuit 311 are different from each other.

The operation switching signals sel0 and sel1 with the two-bit configuration are supplied to the drive signal selection circuit 311 as in the second embodiment. The drive signal selection circuit 311 according to the present embodiment operates like the drive signal selection circuit 311 according to the second embodiment. Note that the configuration may be such that the drive signal selection circuit 311 according to the present embodiment is configured like the drive signal selection circuit 311 according to the first embodiment, and the operation switching signal sel with the one-bit configuration is supplied to the drive signal selection circuit 311 as in the first embodiment.

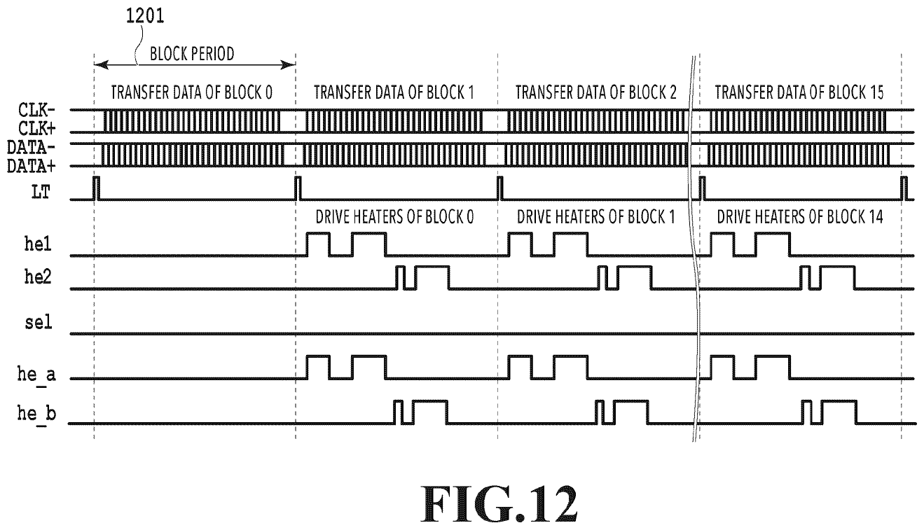

FIG. 12 is a timing chart illustrating an operation in the first operation mode of the print element board according to the third embodiment. As illustrated in FIG. 12, the waveform of the double pulse in the first pre-selection drive signal he1 and the waveform of the double pulse in the second pre-selection drive signal he2 are different from each other. Since the print element board is operating in the first operation mode, the first pre-selection drive signal he1 is selected as the first post-selection drive signal he_a, and the waveform of the first post-selection drive signal he_a is the same as the waveform of the first pre-selection drive signal he1 as illustrated in FIG. 12. Similarly, the second pre-selection drive signal he2 is selected as the second post-selection drive signal he_b, and the waveform of the second post-selection drive signal he_b is the same as the second pre-selection drive signal he2 as illustrated in FIG. 12.

The present embodiment can be applied to, for example, the case where the print elements need to be driven by drive signals that vary depending on the array.

### Other Embodiments

Piezoelectric elements may be used instead of the heaters as the print elements.

The print element board may operate only in any two operation modes selected from the group consisting of the first operation mode to the fourth operation mode in the second embodiment, or operate only in any three operation modes selected from the group. Moreover, in this case, as in the first and second embodiments, the pre-selection drive signal he1 and the pre-selection drive signal he2 may have the same pattern. Moreover, the pre-selection drive signal he1 and the pre-selection drive signal he2 may have patterns different from each other as in the third embodiment.

In the above-mentioned embodiment, explanation is given by using the double pulse pattern as an example of the pattern in which the drive signal intermittently goes into the effective level. However, a pattern with more pulses or a pattern with a single pulse may be used.

The following configuration may be adopted depending on the application. The operation illustrated in FIG. 6 is changed such that the block period is halved, a pulse is generated in the first post-selection drive signal, and the second post-selection drive signal is always set to an ineffective level. Similarly, the following configuration may be adopted depending on the application. The operation illustrated in FIG. 10 is changed such that the block period is halved, a pulse is generated in the first post-selection drive signal, and a period in which the second post-selection drive signal is always set to the ineffective level and a period in which “first” and “second” are interchanged are repeated.

Although the printing apparatus according to the above-mentioned embodiments includes the print head that performs printing by ejecting the inks, a liquid other than the inks may be used instead of the inks.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-047765, filed on Mar. 25, 2024, which is hereby incorporated by reference wherein in its entirety.

What is claimed is:

1. A print element board comprising:
a plurality of first print elements;
a plurality of second print elements;
a plurality of first drive elements configured to drive the plurality of first print elements;
a plurality of second drive elements configured to drive the plurality of second print elements;
a drive signal generation circuit configured to generate a first drive signal and a second drive signal; and
a drive signal selection circuit configured to select both or one of the first drive signal and the second drive signal based on an externally-supplied operation switching signal, wherein
at least one of the first drive elements and at least one of the second drive elements operate based on the drive signal selected by the drive signal selection circuit.

2. The print element board according to claim 1, further comprising a data expansion circuit configured to expand an externally-supplied serial signal based on an externally-supplied clock signal and an externally-supplied latch signal, wherein
the at least one of the first drive elements is a drive element selected from among the plurality of first print elements based on a first element selection signal expanded by the data expansion circuit,
the at least one of the second drive elements is a drive element selected from among the plurality of second print elements based on a second element selection signal expanded by the data expansion circuit, and
the signals expanded by the data expansion circuit are updated every block period.

3. The print element board according to claim 2, wherein
in a case where the operation switching signal indicates a first value, the drive signal selection circuit selects at least one of the first drive signal and the second drive signal for the at least one of the first drive elements, and selects the other one of the first drive signal and the second drive signal for the at least one of the second drive elements, and
in a case where the operation switching signal indicates a second value, the drive signal selection circuit selects the one or the other one of the first drive signal and the second drive signal in common for the at least one of the first drive elements and the at least one of the second drive elements.

4. The print element board according to claim 3, wherein a block period in a case where the operation switching signal indicates the second value is shorter than a block period in a case where the operation switching signal indicates the first value.

5. The print element board according to claim 2, wherein
in a block period in which the operation switching signal indicates a first value, the drive signal selection circuit selects one of the first drive signal and the second drive signal for the at least one of the first drive elements, and selects the other one of the first drive signal and the second drive signal for the at least one of the second drive elements, and
in a block period in which the operation switching signal indicates a third value, the drive signal selection circuit selects the other one of the first drive signal and the second drive signal for the at least one of the first drive elements, and selects the one of the first drive signal and the second drive signal for the at least one of the second drive elements.

6. The print element board according to claim 5, wherein the block period in which the operation switching signal indicates the first value and the block period in which the operation switching signal indicates the third value are alternately repeated.

7. The print element board according to claim 2, further comprising a data expansion circuit configured to expand an externally-supplied serial signal to the first element selection signal, the second element selection signal, the operation switching signal, and a common pattern designation signal designating a pattern of the first drive signal and a pattern of the second drive signal, based on an externally-supplied clock signal and an externally-supplied latch signal.

8. The print element board according to claim 2, further comprising a data expansion circuit configured to expand an externally-supplied serial signal to the first element selection signal, the second element selection signal, and a common pattern designation signal designating a pattern of the first drive signal and a pattern of the second drive signal, based on an externally-supplied clock signal and an externally-supplied latch signal, wherein
the operation switching signal is externally supplied separately from the serial signal.

9. The print element board according to claim 2, further comprising a data expansion circuit configured to expand an externally-supplied serial signal to the first element selection signal, the second element selection signal, the operation switching signal, a first individual pattern designation signal designating a pattern of the first drive signal, and a second individual pattern designation signal designating a pattern of the second drive signal, based on an externally-supplied clock signal and an externally-supplied latch signal.

10. The print element board according to claim 2, further comprising a data expansion circuit configured to expand an externally-supplied serial signal to the first element selection signal, the second element selection signal, a first individual pattern designation signal designating a pattern of the first drive signal, and a second individual pattern designation signal designating a pattern of the second drive signal, based on an externally-supplied clock signal and an externally-supplied latch signal, wherein
the operation switching signal is externally supplied separately from the serial signal.

11. The print element board according to claim 2, further comprising:
a delay element configured to cause the drive signal selected by the drive signal selection circuit for the at least one of the first drive elements to be supplied to the separate first drive elements selectable by the first element selection signal with separate delay times; and
a delay element configured to cause the drive signal selected by the drive signal selection circuit for the at least one of the second drive elements to be supplied to the separate second drive elements selectable by the second element selection signal with separate delay times.

12. The print element board according claim 1, further comprising:
a plurality of first control circuits configured to cause the at least one of the first drive elements to operate based on a selection signal selected by the drive signal selection circuit for the at least one of the first drive elements; and
a plurality of second control circuits configured to cause the at least one of the second drive elements to operate based on a selection signal selected by the drive signal selection circuit for the at least one of the second drive elements.

13. The print element board according to claim 12, further comprising one or both of:
a delay circuit configured to delay the drive signal that is selected by the drive signal selection circuit for the at least one of the first drive elements and that is to be supplied to the plurality of first control circuits; and
a delay circuit configured to delay the drive signal that is selected by the drive signal selection circuit for the at least one of the second drive elements and that is to be supplied to the plurality of second control circuits.

14. The print element board according to claim 1, wherein
the first drive signal has a waveform that causes the first drive elements or the second drive elements to drive the print elements corresponding to the first drive elements or the second drive elements in a first portion of a block period, and
the second drive signal has a waveform that causes the first drive elements or the second drive elements to drive the print elements corresponding to the first drive elements or the second drive elements in a second portion of the block period, the second portion being later than the first portion of the block period in terms of time.

15. The print element board according to claim 14, wherein the waveform of the first drive signal in the first portion and the waveform of the second drive signal in the second portion are the same.

16. The print element board according to claim 14, wherein the waveform of the first drive signal in the first portion and the waveform of the second drive signal in the second portion are different from each other.

17. The print element board according to claim 1, wherein, in the drive signal generation circuit, a portion configured to generate the first drive signal and a portion configured to generate the second drive signal are common, and the drive signal generation circuit generates the first drive signal and the second drive signal based on a common pattern designation signal.

18. The print element board according to claim 1, wherein the drive signal generation circuit includes:
a first drive signal generation circuit configured to generate the first drive signal based on a first individual pattern designation signal; and
a second drive signal generation circuit configured to generate the second drive signal based on a second individual pattern designation signal.

19. A print head using the print element board according to claim 1, the print head comprising a plurality of ejection ports configured to eject liquid.

20. A printing apparatus configured to perform printing on a print medium by using a print head using a print element board including
a plurality of first print elements,
a plurality of second print elements,
a plurality of first drive elements configured to drive the plurality of first print elements,
a plurality of second drive elements configured to drive the plurality of second print elements,
a drive signal generation circuit configured to generate a first drive signal and a second drive signal, and
a drive signal selection circuit configured to select both or one of the first drive signal and the second drive signal based on an externally-supplied operation switching signal, wherein
at least one of the first drive elements and at least one of the second drive elements operate based on the drive signal selected by the drive signal selection circuit,
the print head includes a plurality of ejection ports configured to eject liquid,
the liquid is ink,
the print head is used as a print head configured to eject the ink, and
the ink is ejected from the ejection ports by driving the plurality of first print elements and the plurality of second print elements.
